(19) United States
(12) Patent Application Publication
(10) Pub. No.: US 2011/0242988 A1
(43) Pub. Date: Oct. 6, 2011

(54) SYSTEM AND METHOD FOR PROVIDING PSEUDOWIRE GROUP LABELS IN A NETWORK ENVIRONMENT

(75) Inventors: Sudhir Kumar Rustogi, Cary, NC (US); Iftekhar Hussain, Santa Clara, CA (US)

(73) Assignee: Cisco Technology, Inc.

(21) Appl. No.: 12/754,525

(22) Filed: Apr. 5, 2010

(51) Int. Cl. H04L 12/26

(52) U.S. Cl. 370/242

(57) ABSTRACT

An example method includes identifying a fault condition in a network, and evaluating pseudowires affected by the fault condition in order to make a determination as to whether an aggregate failure occurred in the network for a group of pseudowires. The method also includes communicating a group message indicating that the group of pseudowires is associated with the fault condition. The group message includes a group identification (ID), which identifies the group of pseudowires, and the group message includes a pseudowire group label identifying an in-band aggregate channel. More specifically, the pseudowire group label can be applicable to static pseudowires. In more detailed embodiments, the group ID identifies the group of pseudowires that are associated with an attachment circuit, a label switched path, or a port. Internal mappings can be maintained such that a plurality of pseudowires is mapped to individual interfaces of network elements in the network.

### TECHNICAL FIELD

This disclosure relates in general to the field of communications and, more particularly, to providing pseudowire group labels in a network environment.

### BACKGROUND

The field of communications has become increasingly important in today's society. In particular, the ability to quickly and to effectively provision connections presents a significant challenge to component manufacturers, system designers, and network operators. Multiprotocol Label Switching (MPLS) is a mechanism in telecommunications networks that carries data from one network node to the next. Layer 2 services (such as Frame Relay, Asynchronous Transfer Mode, and Ethernet) can be emulated over an MPLS backbone by encapsulating the Layer 2 Protocol Data Units (PDUs) and transmitting them over pseudowires. Protocols exist for establishing and maintaining the pseudowires. Certain issues have arisen in pseudowire scenarios, where faults are detected in the network.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A is a simplified block diagram of a communication system for providing pseudowire group labels in a network environment in accordance with one embodiment of the present disclosure;

FIG. 1B is a simplified flowchart depicting one possible, generic operational flow associated with the communication system;

FIG. 2 is a simplified block diagram of an example group labeling operation in accordance with one embodiment;

FIG. 3 is a simplified block diagram of another example group labeling operation in accordance with one embodiment;

FIG. 4 is a simplified block diagram of another example group labeling operation in accordance with one embodiment;

FIG. 5 is a simplified block diagram of another example group labeling operation in accordance with one embodiment; and

FIG. 6 is a simplified table of an example set of pseudowire group provisioning parameters in accordance with one embodiment.

### DETAILED DESCRIPTION OF EXAMPLE EMBODIMENTS

### Overview

A method is provided in one example embodiment and includes identifying a fault condition in a network, and evaluating pseudowires affected by the fault condition in order to make a determination as to whether an aggregate failure occurred in the network for a group of pseudowires. The method also includes communicating a group message indicating that the group of pseudowires is associated with the fault condition. The group message includes a group identification (ID), which identifies the group of pseudowires, and the group message includes a pseudowire group label identifying an in-band aggregate channel. More specifically, the pseudowire group label can be applicable to static pseudowires. In more detailed embodiments, the Group ID identifies the group of pseudowires that are associated with an attachment circuit, a label switched path, or a port. Internal mappings can be maintained such that a plurality of pseudowires is mapped to individual interfaces of network elements in the network. The group of pseudowires is static or dynamic, and the group message can be sent over the in-band aggregate channel.

### Example Embodiments

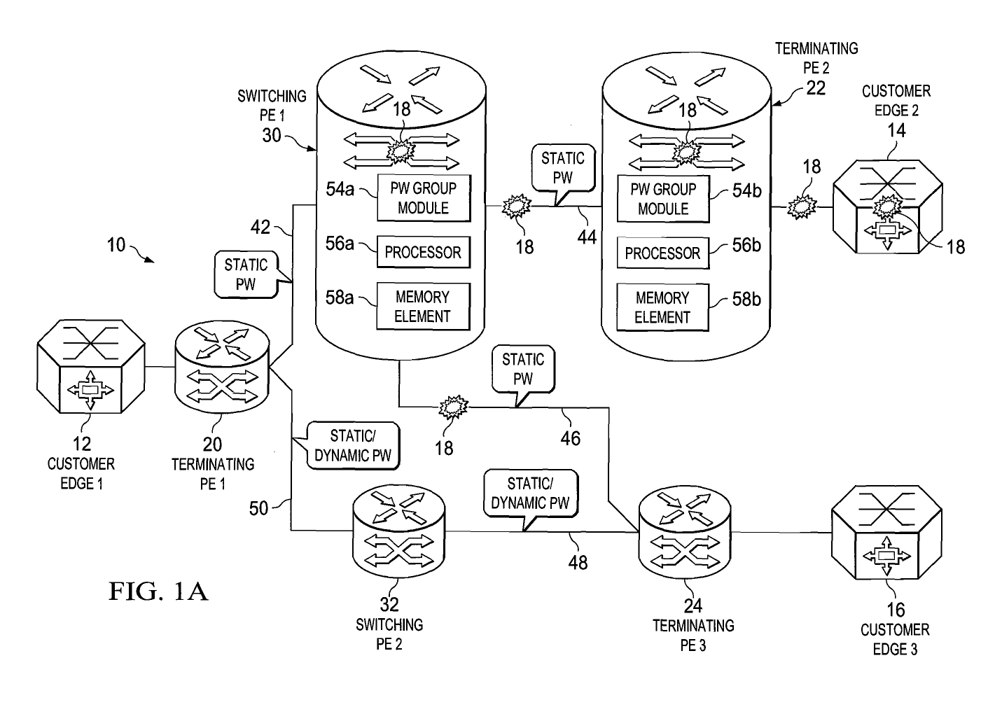

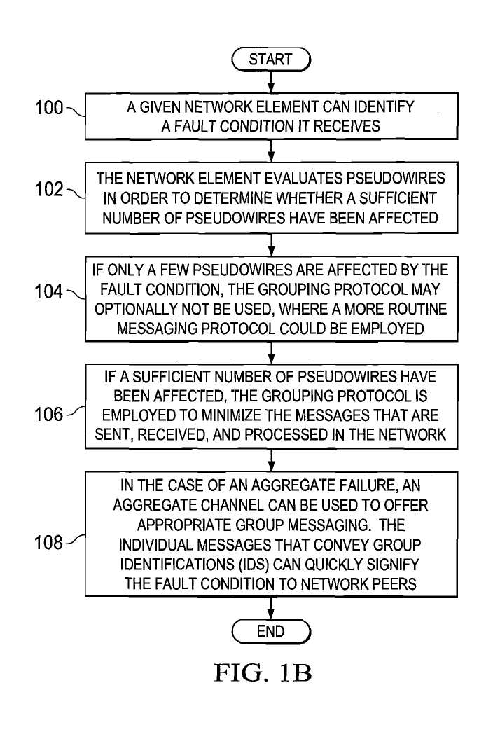

FIG. 1A is a simplified block diagram of a communication system 10 for providing pseudowire group labels in accordance with one example of the present disclosure. FIG. 1A includes a customer edge 1 (CE1) 12, a CE2 14, and a CE3 16, where a number of faults 18 are shown as propagating in the network. Typically, when an error or a failure occurs in the network (e.g., an interface failure, a pulled cable, a switch failure, hardware/software failures generally, etc.), messages are sent to various network devices in order to inform them of these fault conditions. Faults 18 of FIG. 1A are indicative of such messages, where the underlying fault condition (being signaled by the messages) can occur virtually anywhere in a network (e.g., in a customer edge, in provider equipment, etc.). FIG. 1A also includes a terminating provider equipment 1 (TPE1) 20, a TPE2 22, a TPE3 24, a switching provider edge 1 (SPE1) 30, and a SPE2 32. In one particular example implementation, the TPEs and SPEs of FIG. 1A are switches that are configured to exchange data in a network environment.

SPE1 30 may include a pseudowire (PW) group module 54a, a processor 56a, and a memory element 58a. In a similar fashion, TPE2 22 may include a pseudowire group module 54b, a processor 56b, and a memory element 58b. FIG. 1A also includes a number of static pseudowires 42, 44, and 46. A set of static/dynamic pseudowires 48, 50 is also provided. Note that the group labeling protocol discussed herein can be executed between individual SPEs, TPEs, or between any combinations of these elements.

In one particular arrangement, communication system 10 is provided in conjunction with a Layer-2 virtual private networks (L2VPN)/operation, administration, and maintenance (OAM) L2VPN/OAM framework. The OAM framework is intended to provide OAM layering across L2VPN services, pseudowires, and packet switched network (PSN) tunnels. Communication system 10 may include any suitable networking protocol or arrangement that provides a communicative platform for communication system 10. Thus, communication system 10 may include a configuration capable of transmission control protocol/internet protocol (TCP/IP) communications for the transmission and/or reception of packets in a network. Communication system 10 may also operate in conjunction with a user datagram protocol/IP (UDP/IP) or any other suitable protocol where appropriate and based on particular needs.

Before detailing the infrastructure of FIG. 1A, certain contextual information is provided to offer an overview of the problems encountered in pseudowire provisioning. Such information is offered earnestly and for teaching purposes only and, therefore, should not be construed in any way to limit the broad applications for the present disclosure. In network environments, messages that signify fault conditions are commonly sent over a large number of pseudowires. In computer networking and telecommunications, a pseudowire is an emulation of a Layer 2 point-to-point connection-oriented (or connection-less) service over a PSN. The pseudowire can emulate the operation of a “transparent wire” carrying the service.

Failure detection and failure notification for static pseudowires is inadequate, where sluggish signaling can result in poor scalability for failover performance. Typically, static pseudowires are manually configured at respective endpoints, where control channels are absent for providing group level signaling messages. Aggregate channels are significant tools for providing suitable scalability in the network, but no such aggregate channel exists for static pseudowires. For dynamic pseudowires, such an aggregate channel may be present in the form of a label distribution protocol (LDP) directed session. However, no such protocol exists for static pseudowire configurations such that an in-band aggregate channel would be available for static pseudowires.

Communication system 10 can address the aforementioned issues (and others) by offering a pseudowire group label that can represent an aggregate channel for groups of static pseudowires. The aggregate channel of communication system 10 can allow for improved scalability of failover performance. In accordance with one potential configuration of communication system 10, a pseudowire group label is representative of a group of static pseudowires transported over a label switched path (LSP). The pseudowire group label can identify the aggregate channel, which captures the hierarchy relevant to OAM mechanisms. Additionally, the groups represented by the group identification (ID) can be mutually exclusive, where a pseudowire is part of only one group. In other embodiments, a pseudowire can be part of multiple groups, or be configured in any other suitable manner based on particular network arrangements.

During operations, and with brief reference to FIG. 1B, a given network element can identify a fault condition it receives (at step 100) and, subsequently, evaluate pseudowires in order to determine whether a sufficient number of pseudowires have been affected. This is reflected by step 102. If only a few pseudowires are affected by the fault condition, the grouping protocol outlined herein may have only nominal value, where there could be an option to simply communicate the fault condition in a more routine manner, as outlined in step 104. However, if a sufficient number of pseudowires have been affected, the grouping protocol outlined herein can be employed to minimize the messages that are sent, received, and processed in the network. This is reflected as step 106. Note that the determination (as to whether a sufficient number of pseudowires have been impacted by the fault condition) can involve accessing internal tables such that a quick mapping can occur to determine if an aggregate failure has occurred. As used herein, the term ‘aggregate failure’ simply connotes that a sufficient number of pseudowires have experienced the fault condition such that an aggregate channel can be employed to offer appropriate group messaging. For the aggregate failure condition, the individual messages that convey Group identifications (IDs) can quickly signify the fault condition to network peers, as shown in step 108.

In one particular example implementation, a network administrator could offer a bi-directional forwarding detection (BFD) over pseudowire virtual circuit connectivity verification (VCCV) (BFDoVCCV) protocol on the aggregate channel of communication system 10. However, the scalability gains of communication system 10 are not limited to BFDoVCCV. Any other operation, administration, and maintenance (OAM) protocol could benefit from using such an aggregate channel. Additionally, as used herein in this Specification, the term ‘aggregate channel’ simply connotes any type of pathway, or link (wired or wireless) through which data associated with pseudowire grouping messages can propagate.

In specific regards to OAM mechanisms, OAM messages typically result from common failures in the network. These fault conditions can be aggregated such that they are signaled as a single message, which could represent a group of failed pseudowires (as opposed to sending individual messages for each failed pseudowire). Hence, a single message could be sent to represent all the relevant OAM messages propagating in communication system 10. The group label that propagates in communication system 10 provides an architecture with a significant level of aggregation for failed pseudowires (i.e., pseudowires being affected by a given fault condition), particularly for OAM messaging. Moreover, the in-band aggregate channel of communication system 10 is based (at least in part) on the evolving trends of OAM mechanisms, which are required to be fast, responsive, and capable of being implemented in hardware or software. Additionally, in-band OAM protocols are a better measure of the path availability.

In operation of one example implementation, a group label can represent the tuple <attachment circuit (AC) port level grouping, LSP>. This could signify that all pseudowires on an AC port (sought for aggregation) traverse a given LSP. Multiple pseudowire groups can exist within an LSP. Similarly, pseudowires on the same AC port (that traverse a different LSP) can use a different pseudowire group label. Alternatively, an administrator may seek to employ a one-to-one mapping between an LSP and a group label. If that were the case, then only one pseudowire group would exist within an LSP. In scenarios where there is no LSP label in the packet (e.g., due to penultimate hop popping), the pseudowire group label can provide the hierarchy that is appropriate.

In one particular example, the group level pseudowire OAM message can be sent with the following label stack: Explicit/Implicit LSP Label+pseudowire group Label+GAL+ACH+pseudowire OAM with grouping TLV (where GAL=Generic Associated Channel Label, ACH=Associated Channel Header, TLV=Type-Length-Value). If there are multiple LSPs, then one group label can be provisioned for each LSP (for each pseudowire group), where per group messages can be sent on each LSP. The group label does not necessarily have a one-to-one mapping to the grouping of pseudowires implied by the Group ID in the grouping TLV. Note also that the group-based aggregate channel is applicable to static pseudowires, as well as for dynamic pseudowires in certain applications.

As discussed herein, the aggregate channel of communication system 10 can be configured in various ways. For example, and with regards to a first option, a separate label may simply be used to identify a pseudowire group within an LSP. The association of an OAM message and a pseudowire group is straightforward. There could potentially be multiple pseudowire group labels per LSP. As a second option, one group label can be used to identify a common pseudowire group channel on the LSP. In this implementation, one pseudowire group label is provided per LSP. The OAM message association to a pseudowire group is not as simple as the first option. As a third option, one pseudowire is simply designated to convey grouping information (e.g., without using a group label). In this case, there is no need for a pseudowire group label. Again, the OAM message association to a pseudowire group is not as simple as the first option.

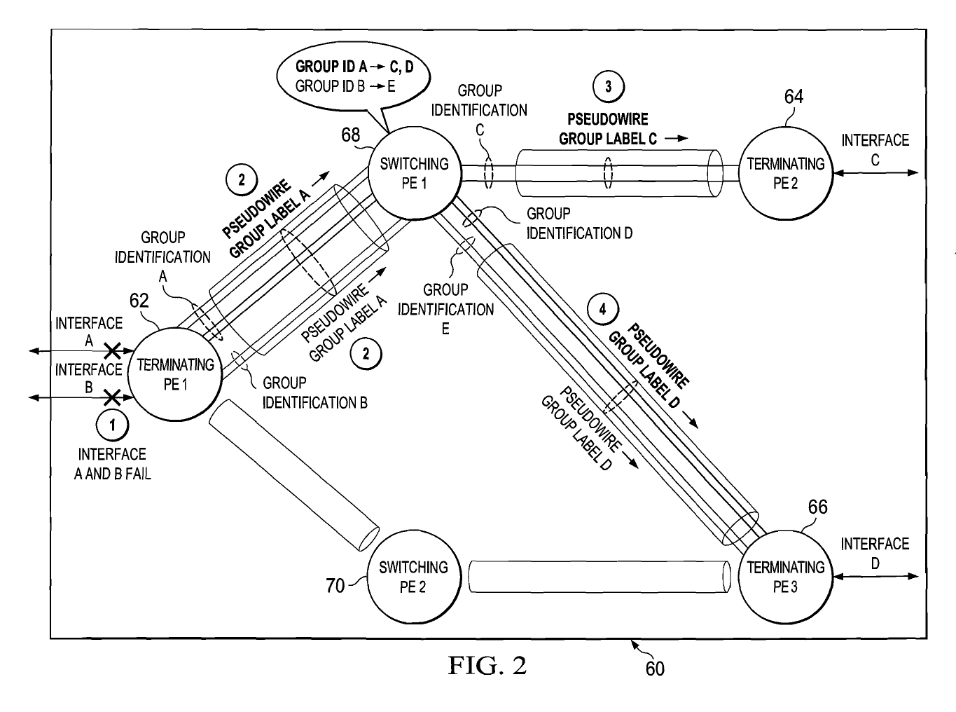

Any combination of formatting (for the Group ID and the pseudowire group label) can be used in the group message to be communicated in the network. In one example, only one of these elements is communicated when an aggregate fault condition is detected, or these elements can be combined into a single unique identifier. In the most generic example, a group message would at least include the Group ID (identifying the pseudowires affected by the fault) and a pseudowire group label (identifying an aggregate channel for communicating the group message). In this generic sense, a pipe (the Group ID) within a pipe (the pseudowire group label) is being identified, where the group message is identifying both elements during an aggregate fault condition. Operational details of communication system 10 are described below with reference to FIGS. 2-6. Note that before turning to additional example flows and example embodiments of the present disclosure, a brief overview of the infrastructure of communication system 10 is provided.

CE1 12, CE2 14, and CE3 16 represent devices, infrastructure, equipment, clients, or customers seeking to initiate a data session in communication system 10. These elements may can comprise a digital subscriber line access multiplexer (DSLAM), a router, a personal computer, a server, a switch, and/or other devices associated with data propagation. Further, these elements may sit behind, or in front of, one or more of these identified devices. The term ‘CE’ may be inclusive of the devices identified above (e.g., a DSLAM, a switch, etc.), as well as devices used to initiate a communication, such as a console, a proprietary endpoint, a telephone, a cellular telephone, a bridge, a computer, a personal digital assistant (PDA), a laptop or an electronic notebook, or any other device, component, element, or object capable of initiating voice, audio, media, or data exchanges within communication system 10. The customer element may also include any device that seeks to initiate a communication on behalf of another entity or element, such as a program, a database, or any other component, device, element, or object capable of initiating a voice, a video, text, or a data exchange within communication system 10. Data, as used herein in this document, refers to any type of video, numeric, voice, media, or script data, or any type of source or object code, or any other suitable information in any appropriate format that may be communicated from one point to another.

In one example, a service provider may provide various network services to a number of customers via CE1 12, CE2 14, and CE3 16. Such services may be associated with an Internet, an intranet, an extranet, a virtual private network (VPN), a virtual local area network (VLAN), etc. Each customer may use at least one customer edge device for transferring network traffic between the customer site and the network. In one example implementation, CE1 12, CE2 14, and CE3 16 can be routers at the customer premises that are connected to the provider edge of a service provider IP/MPLS network. CE1 12, CE2 14, and CE3 16 of FIG. 1A may be used in an Ethernet Layer 2 (L2) VPN, or in other L2-based network configurations, and thus, a customer edge device may be configured in order to coordinate Ethernet L2 service characteristics. L2 may respond to service requests from the network layer (Layer 3) and issue service requests to the physical layer (Layer 1). CE1 12, CE2 14, and CE3 16 may be used in other layers where appropriate and is not relegated to solely L2 activities. L2 may be used to transfer data between adjacent network nodes in a wide area network (WAN) or between nodes on the same local area network (LAN) segment. L2 may provide the functional and procedural mechanisms to transfer data between network entities and may provide detection and correction of errors that may occur in Layer 1. Examples of L2 protocols are Ethernet, point-to-point protocol (PPP), high-level data link control (HDLC), and advanced data communication control procedures (ADCCP) for point-to-point connections. Other standards or non-standard data transfer protocols may be used in conjunction with the architecture of FIG. 1A.

Customer edge (CE) devices may be configured after connection to a network, such as after a customer edge device has been connected and authorized by a provider edge device, which is part of a network. Upon receiving the Ethernet local management interface (E-LMI) protocol status query, a provider edge device may execute a suitable identification scheme. This allows identification of a particular CE device requesting configuration data to ensure the CE device is authorized to be part of the network. The provider element device may also execute an authentication/authorization application to authenticate and to authorize the presence of a CE device on the network. In one example, the provider edge device may authenticate and authorize a CE device based on an identification of the CE device such as a media access control (MAC) address, previously stored by the provider edge device during initial connection of the CE device. The authentication/authorization application may be implemented through various suitable protocols such as through a port-based protocol, through an IEEE 802.1x protocol, through Dynamic Host Configuration Protocol (DHCP), through PPPoE, through E-LMI with extensions, or through some other appropriate protocol or application.

Certain components of FIG. 1A may be coupled together via a packet switched network, which represents a series of points or nodes of interconnected communication paths for receiving and transmitting packets of information that propagate through communication system 10. The packet switched network offers a communicative interface between network elements and may be any LAN, wireless LAN (WLAN), metropolitan area network (MAN), virtual LAN (VLAN), virtual private network (VPN), WAN, or any other appropriate architecture or system that facilitates communications in a network environment.

SPE1 30, SPE2 32, TPE1 20, TPE2 22, and TPE3 24 are network elements that facilitate communications in two directions in a network environment. In one particular example, each of these network elements is a switch configured to exchange data over static and/or dynamic pseudowire links. Further, the traffic exchanged between these components may be directed over an MPLS transport in certain embodiments. As used herein in this Specification, the term ‘network element’ is meant to encompass switches, routers, bridges, gateways, servers, processors, loadbalancers, firewalls, or any other suitable device, component, element, or object operable to exchange or process information in a network environment. Moreover, these network elements may include any suitable hardware, software, components, modules, interfaces, or objects that facilitate the operations thereof. This may be inclusive of appropriate algorithms and communication protocols that allow for the effective exchange of data or information. Along similar design alternatives, any of the internal modules and components of these network elements may be combined in various possible configurations.

Software for achieving the pseudowire group protocol discussed herein can be provided at various locations. In one example implementation, this software is resident in SPE1 30 and/or TPE2 22 (e.g., within pseudowire group modules 54a-54b respectively). In other examples, this could involve a proprietary element, which could be provided in (or be proximate to) these identified network elements, or be provided in any other device, or be provisioned somewhere else in the network. In other embodiments, the pseudowire group protocol feature may be provided externally to SPE1 30 and/or TPE2 22, or included in some other network device, or a computer to achieve these intended functionalities. Alternatively, several elements (SPE1 30 and/or TPE2 22) can include appropriate software (or reciprocating software) that can coordinate in order to achieve the pseudowire group protocol operations outlined herein. In still other embodiments, one, two, or more devices may include any suitable algorithms, hardware, software, components, modules, interfaces, or objects that facilitate the operations associated with pseudowire group labeling functions as discussed herein.

Turning to FIG. 2, FIG. 2 is a simplified block diagram of an example system 60 for providing an example use case using per-label switched path (LSP) pseudowire group labels. FIG. 2 includes a TPE1 62, a TPE2 64, a TPE3 66, a SPE1 68, and a SPE2 70. Each pseudowire group is identified, where a group identification (ID) for Group A and Group B is depicted at TPE1 62. Similarly, Groups C, D, and E have Group IDs at SPE1 68. TPE2 64 and TPE3 66 can couple to interfaces C and D, respectively.

In this particular example, interfaces A and B have failed. Note that there is a multitude of attachment circuits (e.g., 1000 attachment circuits) that are being transported over these interfaces A and B, where the attachment circuits are being tunneled into a corresponding number of pseudowires. For example, there could be 500 attachment circuits on interface A (implicating 500 pseudowires) and 500 attachment circuits on interface B, where the fault condition for the pseudowires should be signaled. In other flawed systems, an architecture would individually signal this fault condition for each pseudowire (e.g., via signaling between TPE1 62 and SPE1 68). Instead of sending 500 messages, a single message can be sent, where a single label (and Group ID) can be used to identify the pseudowires. In this case, the Group ID A is used to signal the fault condition for 300 pseudowires and for 200 pseudowires (i.e., the top two links connecting TPE1 62 and SPE1 68) using a single message (that includes Group Label A and Group ID A). Thus, the status for Group A is quickly communicated to SPE1 68. Similarly, Group ID B can be used to signal the status of the other 500 pseudowires to appropriately convey the status for Group B. More specifically, the message can include Group Label A and Group ID B. Note that all 1000 pseudowires have effectively been accounted for using these Group IDs A and B.

SPE1 68 can receive single messages (more quickly than receiving 500 messages, 1000 messages, etc.) and, subsequently, generate simplified (i.e., single) messages to each of TPE2 64 and TPE3 66. Hence, each individual Group ID can have an associated group value. For example, Group A could be associated with 500 pseudowires such that when TPE1 62 sends the initial message to SPE1 68, SPE1 68 can readily recognize the fault condition associated with the corresponding pseudowires. Similarly, when SPE1 68 sends its status message for Group C (where the message includes Group Label C and Group ID C), Group C maps to 300 pseudowires such that the receiving node (TPE2 64) understands that this message applies to those specific pseudowires. In an analogous fashion, the group values sent by SPE1 68 to TPE3 66 could be provided as Group D and Group E (mapping to 200 pseudowires and 500 pseudowires), where the receiving node (TPE3 66) understands that this message pertains to those identified 700 pseudowires. Thus, for the status of Group D, a message (that includes Group Label D and Group ID D) can be sent for 200 pseudowires and for 500 pseudowires (where the message includes Group Label D and Group ID E). This signaling of 300, 200, and 500 pseudowires accounts for the original 1000 pseudowires for which fault condition signaling was required.

In one particular example, during a provisioning phase, each TPE and SPE can be provided with a mapping that identifies the group labels being provided for each set of pseudowires. Alternatively, configuration data can be pushed (or otherwise sent, updated, etc.) to each TPE and SPE (at any appropriate time) to offer the appropriate mapping between group labels (and/or Group IDs) and specific pseudowires.

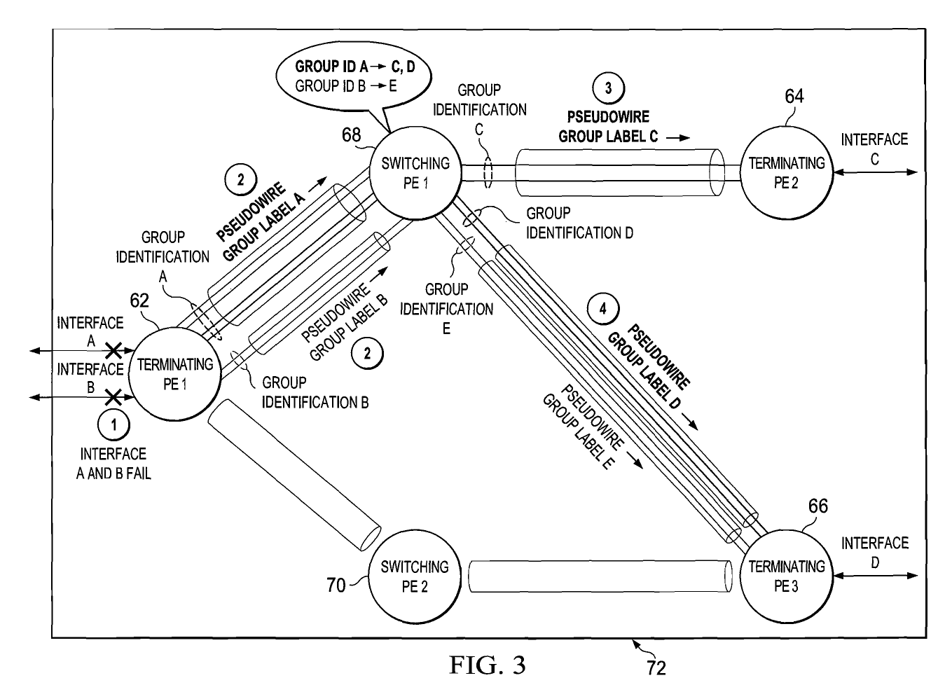

FIG. 3 is a simplified block diagram of an example system 72 for providing another use case for pseudowire group labels. Note that the grouping mechanism outlined herein is not limited to pseudowires that propagate over LSPs. Certain pseudowires can propagate over an LSP and represent one group, where two ports can be provisioned for two different groups (e.g., Group A and Group B). Hence, FIG. 3 is depicting a use case using pseudowire group labels for <port, LSP>mapping. In a general sense, such a configuration is showing how pseudowire mechanics can be used to offer different group signaling, which may be based on various possible implementations. Thus, there is a group level construct corresponding to the group labels that are created such that any OAM protocol can send the appropriate aggregate messages. In this particular example, the signaling for Group ID A, B, C, and D is similar to that of FIG. 2; however, the grouping mechanism has simply changed.

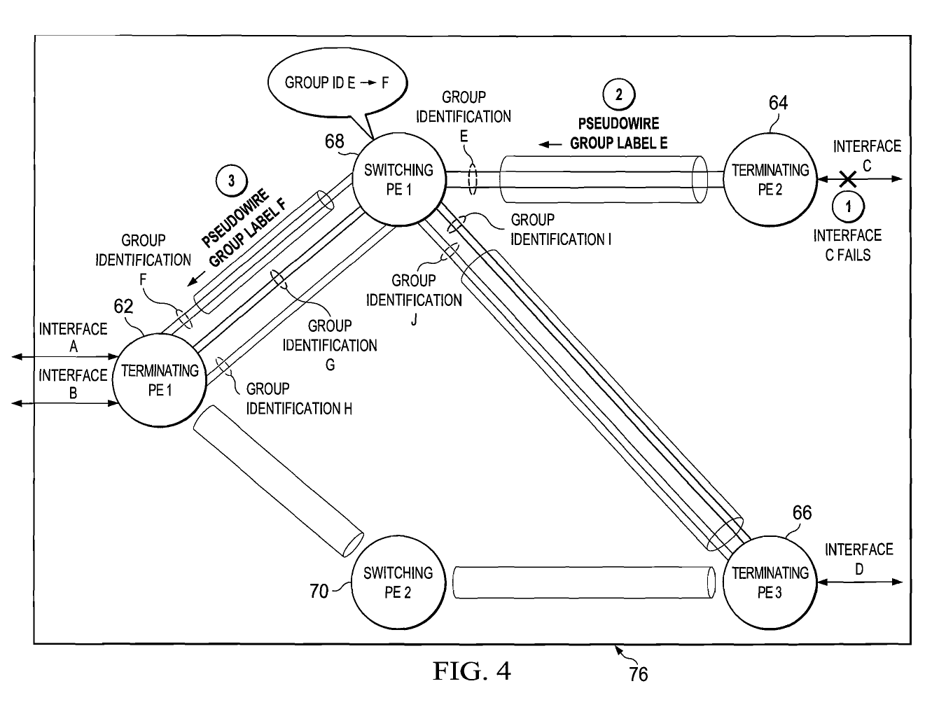

FIG. 4 is a simplified block diagram of an example system 76 for providing another use case for pseudowire group labels. In this particular example, interface C fails (as shown at TPE2 64). Note that the same logical flow occurs in FIG. 4 in terms of the group signaling, as previously discussed. The group labels in two directions do not have to be the same, where the groupings for the messaging are not necessarily symmetrical. In this particular example, TPE2 64 sends a status for Group E with the corresponding group label (i.e., Group ID E for 300 pseudowires), where that message will have a Group Label E and a Group ID E. Hence, this particular signaling is indicative of 300 pseudowires failing in the network. SPE1 68 can send the status for Group F (where the Group ID F is associated with 300 pseudowires) to TPE1 62, where that message includes a Group Label F and a Group ID F.

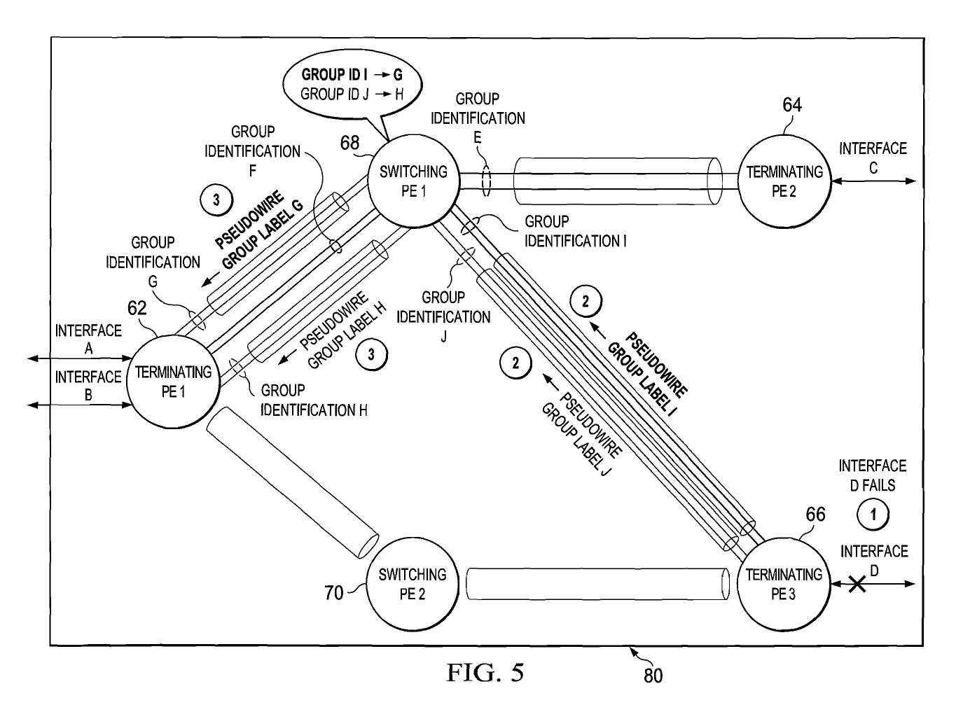

FIG. 5 is a simplified block diagram of an example system 80 for providing another use case for pseudowire group labels. In this particular example, interface D fails (as shown at TPE3 66), where all 700 pseudowires fail. In one implementation, TPE3 66 does not have a 700 pseudowire Group ID. Instead, the Group IDs can correspond to 200 and 500 pseudowires, when summed together account for the 700 pseudowires. In this particular example, TPE3 66 sends one message for Group I (representing 200 pseudowires) and another message for Group J (representing 500 pseudowires) to SPE1 68. In response, SPE1 68 sends a message for Group G (representing 200 pseudowires) and another message for Group H (representing 500 pseudowires). Again, the signaling being exchanged between these elements is minimal due to the effective grouping of pseudowires. SPE1 68 also sends a single message for Group I (associated with 200 pseudowires) and Group J (associated with 500 pseudowires) to TPE3 66, which is coupled to interface D. Group ID G is associated with 200 pseudowires, whereas Group ID H is representative of 500 pseudowires.

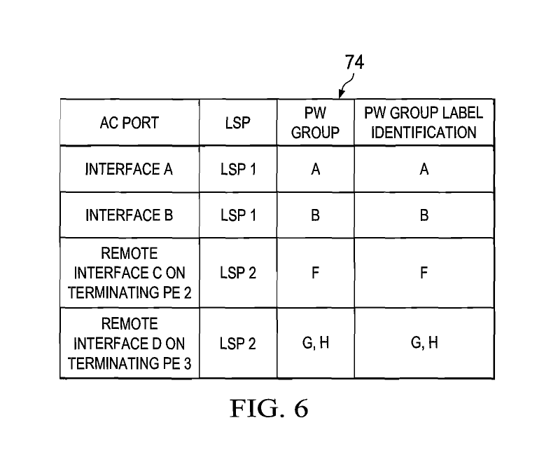

FIG. 6 is a simplified table 74 illustrating an example set of pseudowire group provisioning parameters for TPE1 62, where these particular provisioning parameters could be relevant to the configuration of FIG. 3. At least in one generic sense, FIG. 2 can reflect one approach for mapping a PW group label to a PW Group ID, while FIGS. 3-5 can reflect a second approach for such mappings, where table 74 is associated with that second approach.

In particular, table 74 illustrates the mapping between SPE1 68 and TPE1 62. The first column represents the attachment circuit port (e.g., interface A, interface B, remote interface C on TPE2 64, and remote interface D on TPE3 66). Additionally, table 74 depicts a number of LSPs, a set of pseudowire grouping labels, and a set of pseudowire Group IDs. Note that the Group IDs are provided inside the pseudowire group labels in this example such that these two columns match in table 74. Additionally, note that table 74 is merely representing some of the possible characteristics in a single direction, where different constructs could be used in the reverse direction. Note that the provisioning as discussed herein can significantly reduce messaging such that these presented concepts offer increased scalability. This is due in part to the nominal processing that occurs in the network, in contrast to the processing required to evaluate a prolific amount of signaling messages associated with particular pseudowires. Additionally, the paradigm discussed herein can afford service providers an adequate amount of downtime after a failure has occurred in the network.

In certain example implementations, the pseudowire group functions outlined herein may be implemented by logic encoded in one or more tangible media (e.g., embedded logic provided in an application specific integrated circuit (ASIC), digital signal processor (DSP) instructions, software (potentially inclusive of object code and source code) to be executed by a processor, or other similar machine, etc.). In some of these instances, a memory elements (as shown in FIG. 1A) can store data used for the operations described herein. This includes the memory elements being able to store software, logic, code, or processor instructions that are executed to carry out the activities described in this Specification. A processor can execute any type of instructions associated with the data to achieve the operations detailed herein in this Specification. In one example, the processors (as shown in FIG. 1A) could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable ROM (EEPROM)) or an ASIC that includes digital logic, software, code, electronic instructions, or any suitable combination thereof.

Any of these elements (e.g., SPE1 30, TPE2 22, etc.) can include memory elements for storing information to be used in achieving the pseudowire group operations as outlined herein. Additionally, each of these devices may include a processor that can execute software or an algorithm to perform the pseudowire group activities as discussed in this Specification. These devices may further keep information in any suitable memory element (random access memory (RAM), ROM, EPROM, EEPROM, ASIC, etc.), software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Note that with the examples provided herein, interaction may be described in terms of two, three, four, or more network elements. However, this has been done for purposes of clarity and example only. In certain cases, it may be easier to describe one or more of the functionalities of a given set of flows by only referencing a limited number of components or network elements. It should be appreciated that communication system 10 of FIG. 1A (and its teachings) are readily scalable. Communication system 10 can accommodate a large number of components, as well as more complicated or sophisticated arrangements and configurations. Accordingly, the examples provided should not limit the scope or inhibit the broad teachings of communication system 10 as potentially applied to a myriad of other architectures.

It is also important to note that the steps described with reference to the preceding FIGURES illustrate only some of the possible scenarios that may be executed by, or within, communication system 10. Some of these steps may be deleted or removed where appropriate, or these steps may be modified or changed considerably without departing from the scope of the discussed concepts. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings of the discussed concepts.

What is claimed is:

1. A method, comprising:
identifying a fault condition in a network;
evaluating pseudowires affected by the fault condition in order to make a determination as to whether an aggregate failure occurred in the network for a group of pseudowires; and
communicating a group message indicating that the group of pseudowires is associated with the fault condition, wherein the group message includes a group identification (ID), which identifies the group of pseudowires, and wherein the group message includes a pseudowire group label identifying an in-band aggregate channel.

2. The method of claim 1, wherein the group ID is mapped to the pseudowire group label identifying the in-band aggregate channel over which the group message is sent.

3. The method of claim 1, further comprising:
mapping the group of pseudowires to the group ID in order to communicate the group message.

4. The method of claim 1, wherein the group ID identifies the group of pseudowires that are associated with an attachment circuit, a label switched path, and a port.

5. The method of claim 1, wherein internal mappings are maintained such that a plurality of pseudowires is mapped to individual interfaces of network elements in the network.

6. The method of claim 1, wherein the group of pseudowires is static or dynamic, and the group of pseudowires are part of an interface associated with a network element.

7. The method of claim 1, wherein if a determination is made that the aggregate failure did not occur, then multiple single messages are sent to identify individual pseudowires that are associated with the fault condition.

8. Logic encoded in one or more tangible media that includes code for execution and when executed by a processor operable to perform operations comprising:
identifying a fault condition in a network;
evaluating pseudowires affected by the fault condition in order to make a determination as to whether an aggregate failure occurred in the network for a group of pseudowires; and
communicating a group message indicating that the group of pseudowires is associated with the fault condition, wherein the group message includes a group identification (ID), which identifies the group of pseudowires, and wherein the group message includes a pseudowire group label identifying an in-band aggregate channel.

9. The logic of claim 8, wherein the group ID is mapped to the pseudowire group label identifying the in-band aggregate channel over which the group message is sent.

10. The logic of claim 8, the processor being further operable to perform operations comprising:
mapping the group of pseudowires to the group ID in order to communicate the group message.

11. The logic of claim 8, wherein the group ID identifies the group of pseudowires that are associated with an attachment circuit, a label switched path, and a port.

12. The logic of claim 8, wherein internal mappings are maintained such that a plurality of pseudowires is mapped to individual interfaces of network elements in the network, and wherein if a determination is made that the aggregate failure did not occur, then multiple single messages are sent to identify individual pseudowires that are associated with the fault condition.

13. The logic of claim 8, wherein the group of pseudowires is static or dynamic, and the group of pseudowires are part of an interface associated with a network element.

14. An apparatus, comprising:
a memory element configured to store data,
a processor operable to execute instructions associated with the data, and
a group module configured to interface with the processor and the memory element in order to:
identify a fault condition in a network;
evaluate pseudowires affected by the fault condition in order to make a determination as to whether an aggregate failure occurred in the network for a group of pseudowires; and
communicate a group message indicating that the group of pseudowires is associated with the fault condition, wherein the group message includes a group identification (ID), which identifies the group of pseudowires, and wherein the group message includes a pseudowire group label identifying an in-band aggregate channel.

15. The apparatus of claim 14, wherein the group ID is mapped to the pseudowire group label identifying the in-band aggregate channel over which the group message is sent.

16. The apparatus of claim 14, wherein the group module is further configured to:
map the group of pseudowires to the group ID in order to communicate the group message.

17. The apparatus of claim 14, wherein the group ID identifies the group of pseudowires that are associated with an attachment circuit, a label switched path, and a port.

18. The apparatus of claim 14, wherein internal mappings are maintained in the memory element such that a plurality of pseudowires is mapped to individual interfaces of network elements in the network.

19. The apparatus of claim 14, wherein the group of pseudowires is static or dynamic, and the group of pseudowires are part of an interface associated with a network element.

20. The apparatus of claim 14, wherein if a determination is made that the aggregate failure did not occur, then multiple single messages are sent to identify individual pseudowires that are associated with the fault condition.
